(19) United States
(12) Patent Application Publication
(10) Pub. No.: US 2003/0107175 A1
(43) Pub. Date: Jun. 12, 2003

(54) Multihand poker game

(76) Inventors: David Allen Loewenstein, Rye Brook, NY (US); Martin Joel Wolff, New York, NY (US)

Correspondence Address: David Loewenstein, 802 King Street, Rye Brook, NY, 10573, US

(21) Appl. No.: 10/211,063

(22) Filed: Aug. 2, 2002

Related U.S. Application Data
(63) Continuation-in-part of application No. 10/015,314, filed on Dec. 11, 2001.

(51) Int. Cl. A63F 13/00

(52) U.S. Cl. 273/292; 463/12; 273/274

(57) ABSTRACT

This invention is a multi-handed poker game where the cards are dealt in one or more diamond patterns. In one embodiment, each side of the diamond is a separate hand. In some embodiments, the cards can be exchanged from one hand to another. In another embodiment, there is no card exchange; the cards are dealt, the player decides which cards to hold and the non-held cards are replaced. In another embodiment, the diamond or diamonds (in multiple hands) have one card in each corner and the fifth card in the center of the diamond. In this version of the game, the diamonds can be linked and so that the corner cards are common to one or more adjacent hands.

This is a continuation in part of application Ser. No. 10/15,314 the entirety of that application is incorporated in this application by reference.

This invention is for poker games that can be played on electronic devices of the sort typically used in casinos. The game can also be played over the internet or on hand held video games. In short, the patent covers playing the game, on any sort of electronic device, or transmitting electronic signals that represent the game from one computer to another.

In one embodiment of the game, cards are dealt in a diamond pattern with five cards on a side, with the corner cards common to adjacent hands. The cards are all dealt face up, and the player is given an opportunity to select hold cards. The non-held cards are replaced and the resulting hands are compared to a pay table.

In another embodiment of the game, the diamond pattern is created with seven cards on a side, and the corner cards are common to adjacent hands. In this embodiment, some or all of the cards can be dealt face up. The player can then swap cards from one hand into another. The resulting hands are then compared to a pay table and the player is paid accordingly.

In another embodiment of the game, five cards are dealt per side and there is an internal cross of cards made up of three cards in each direction, which makes a horizontal and vertical five-card hand in combination with the corner cards.

In another embodiment, diamond-shaped hands are made of five cards, four corner cards and a center card. A number of these diamonds can be linked together with the corner cards from one hand also being the corner cards of an adjacent hand, or of adjacent hands. The player can pay for the number of hands he wants to play. For example he can pay four quarters for four hands.

### DESCRIPTION OF THE FIGURES

FIG. 1 shows a five card per side diamond pattern poker game.

FIG. 2 shows the seven card per side diamond pattern poker game.

FIG. 3 shows the five card per side diamond pattern game with an internal cross of five cards horizontally and vertically.

FIG. 4 shows an embodiment of the game which is a series of interlocking five-card, diamond-shaped hands.

Appendix I is a computer program in visual basic that plays several of these games. However, as of the filing date we have not yet completed the programming for all games.

### DETAILED DESCRIPTION OF THE INVENTION

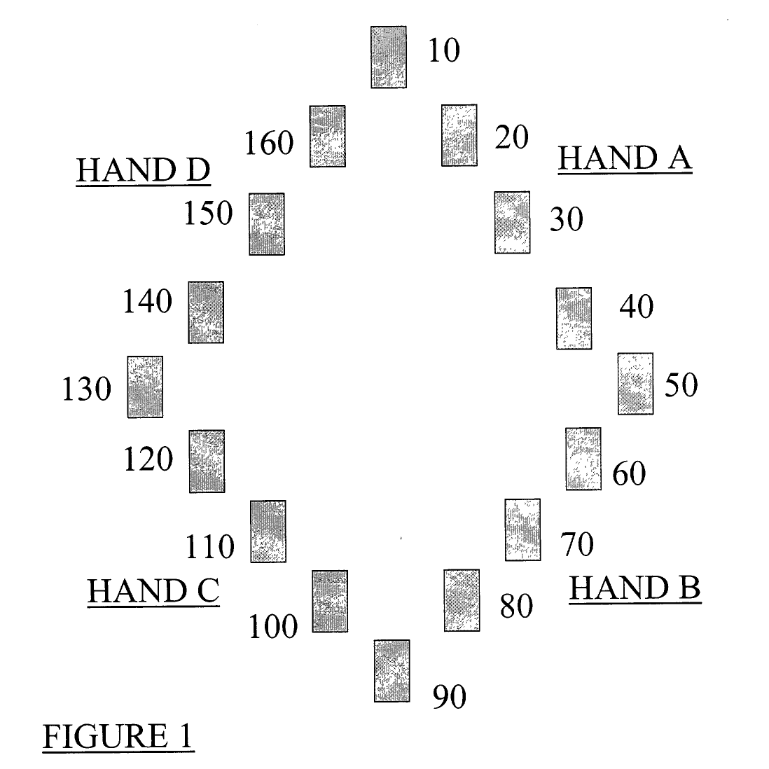

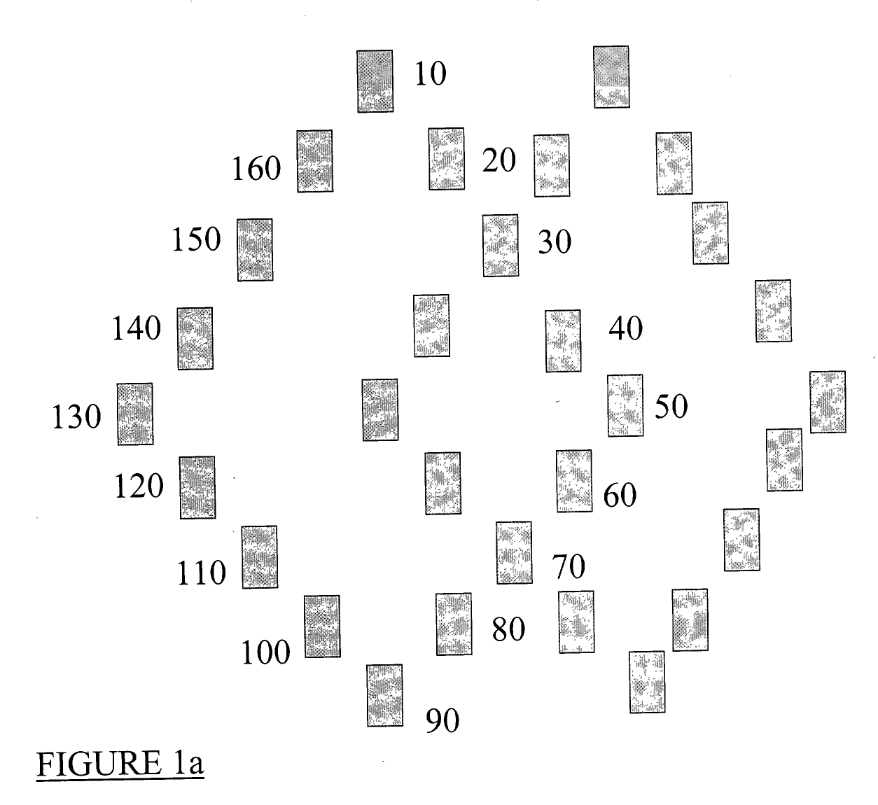

FIG. 1 shows a diamond pattern of cards with five cards dealt per side. We have found the most enjoyable way to play the game is to deal the corner cards face down (i.e., 10, 50, 90 and 130) and the three internal cards face up (e.g., 20, 30, 40). In the preferred embodiment, the player is then permitted to swap three pairs of cards. This can be done by placing a screen cursor on the first card, which is then highlighted, then moving the cursor to the card the player wants to swap. After the second card is selected, the two cards exchange positions, giving the player two different, and hopefully better hands.

In a commercial embodiment, swapping probably would be done with a touch screen. It is also possible to suggest to the player which cards should be swapped to speed-up play of the game. Similarly, it is possible to highlight common cards (e.g., a pair of aces) in different hands to suggest to the player which cards should be exchanged.

This game could require the player to pay for each swap, or to pay for swaps above a preset number.

FIG. 1 also shows a five-card diamond pattern game without swapping. In this embodiment, all cards are dealt face up. The player then decides which cards to hold. The non-held cards are replaced with new cards. In a related embodiment, it would be possible to return discarded cards to the deck. If this version were used, the player could receive as re-dealt cards the same cards that had already been displayed and had not been held.

Diamond shapes are shown as the preferred embodiment, but other figures can also be used. For example, a two-line (i.e., two hand) game can be played where the end cards are common to the three-interior cards for each game. Triangles, squares and pentagons, etc. are also contemplated by this invention. Obviously, the display of this game could be rotated 45 degrees so that the shape is a square rather than a diamond without departing from the spirit of the invention. Furthermore, the cards do not have to appear in straight lines for each side of the closed figure. Some curvature would not deviate from the concept of this invention.

This game can include a feature where the player is required to pay for each hand in the n-sided closed figure. In this embodiment, for example, the player would be required to pay four coins (or betting units) for a diamond pattern, and five units for a pentagon. Players could also bet more on certain hands. This feature is common throughout the various games disclosed in this specification.

This game could also be played with a bonus or progressive jackpot. For example, if a deck that includes jokers were used, and a joker were dealt in the corner, the player would be paid a bonus. Another bonus or progressive jackpot could be paid if four aces were dealt in the corner cards. Other bonuses could be paid if lower rank four of a kinds were dealt in the corners.

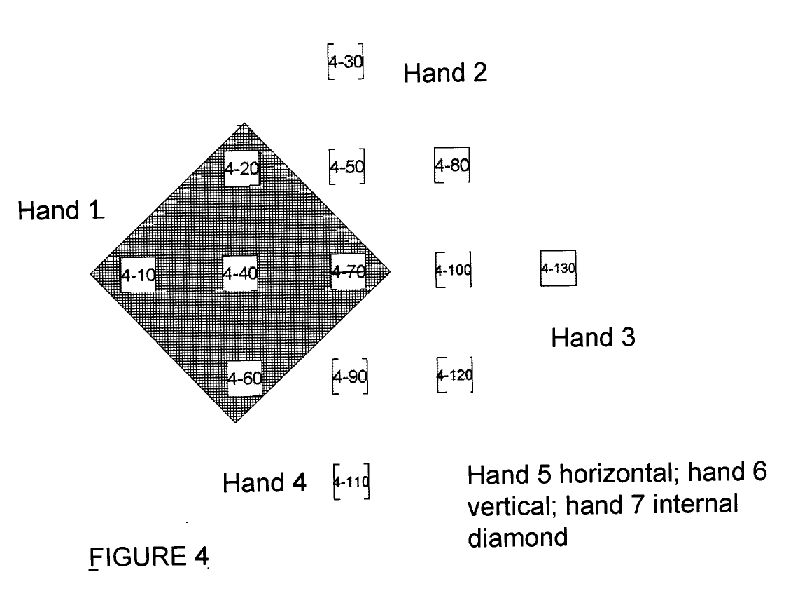

Diamonds could be linked together, similar to what is shown in FIG. 4, to create additional hands.

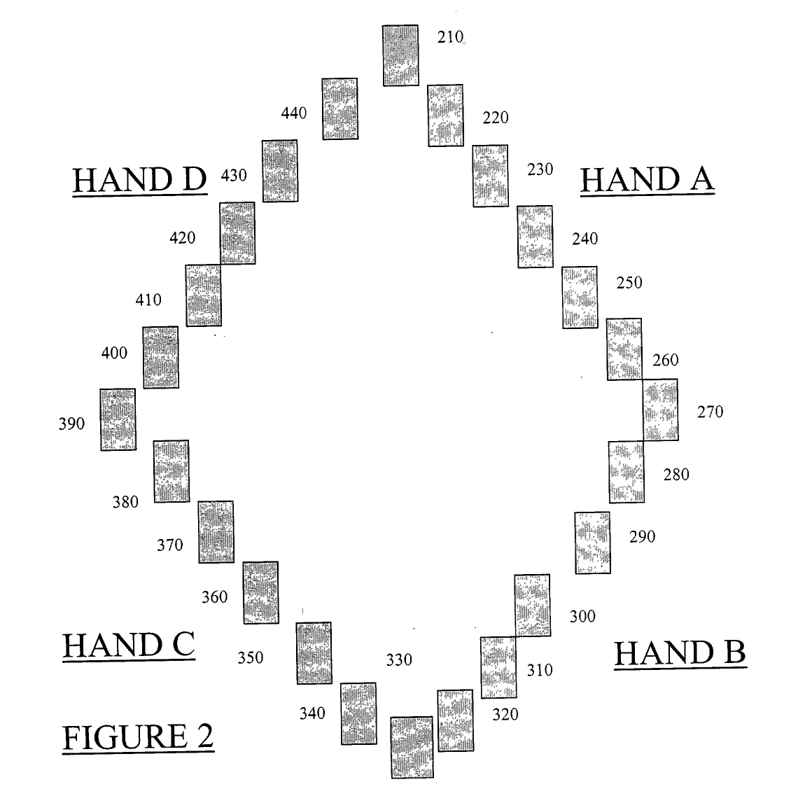

FIG. 2 shows a seven-card version of the game. The game can be played with swapping or it can be played with hold cards and re-dealing. The bonus games can be played as well. Because of the large number of cards on the screen, we have found it somewhat less confusing to deal the corner cards down and the center-side cards face down (e.g., 240). However, this game is very flexible and any number of cards can be dealt face up or down, and the number of swaps can vary.

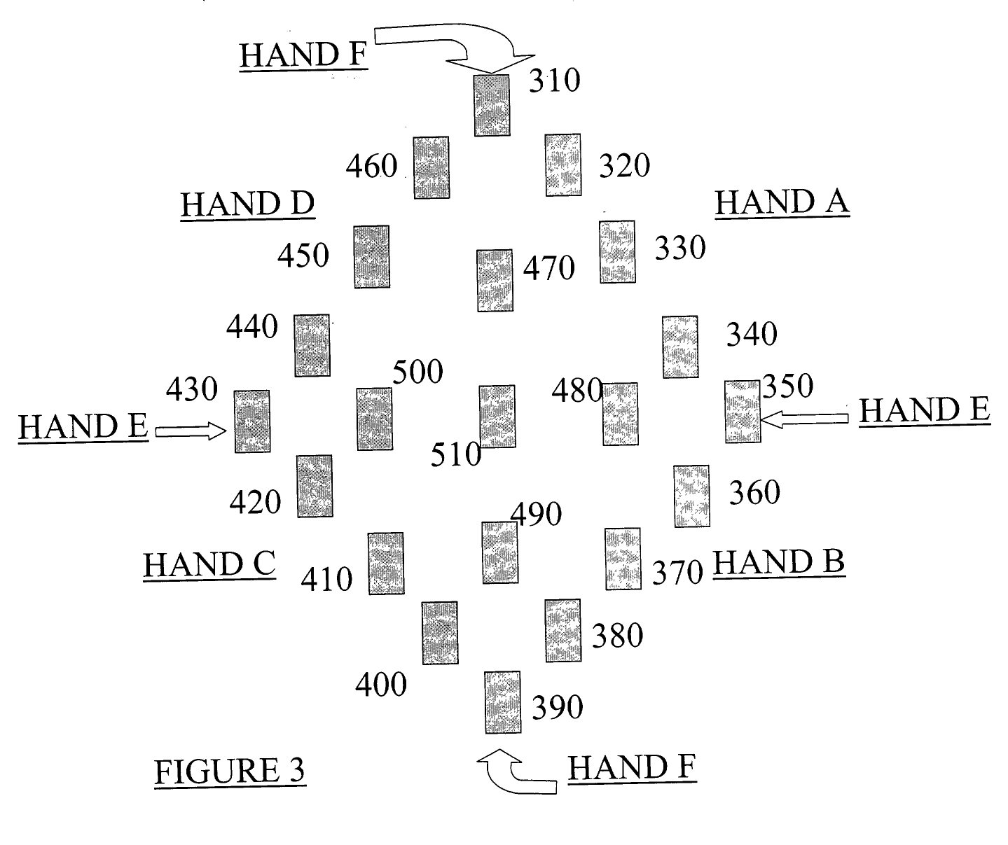

FIG. 3 shows another variation of the game where each side of the diamond is composed of five cards. Each side is a separate hand and the horizontal line of cards (i.e., 430, 500, 510, 480 and 350) and vertical line (i.e., 310, 470, 510, 490 and 390) each form a separate hand. If a joker deck is used, a bonus could be paid if the center or corner card were a joker. The internal diamond (i.e., 500, 470, 480, 490 and 510) could form another hand.

In another embodiment, shown in FIG. 4, a five-card hand is dealt in a diamond pattern with one card in each corner and a center card. The player can choose how many diamond hands will be dealt. For example, the player could buy one hand for each coin (or betting unit) deposited. For this and all other embodiments, in machines that use electronic cards instead of coins, the player could be charged for each hand. Obviously, dollar bills could substitute for coins.

In this embodiment, shown in FIG. 4, if the player paid for one hand he would be dealt one hand, for example, cards 4-10, 4-20, 4-40, 4-60 and 4-70. In FIG. 4, there are at least seven hands:

| | |
|---|---|
| Hand 2 | 4-20, 4-30, 4-50, 4-70 and 4-80 |
| Hand 3 | 4-70, 4-80, 4-100, 4-120 and 4-130 |
| Hand 4 | 4-60, 4-70, 4-90, 4-110 and 4-120 |
| Hand 5 | 4-10, 4-40, 4-70, 4-100 and 4-130 |
| Hand 6 | 4-30, 4-50, 4-70, 4-90 and 4-110 |
| Hand 7 | 4-40, 4-50, 4-70, 4-90 and 4-100. |

The sides could also form hands. For example, cards 4-110, 4-120, 4-130, 4-80 and 4-30 could form a hand. Similarly, hands could be formed from the following arrangements: 4-110, 4-60, 4-10, 4-20, and 4-30; and an internal “X” 4-20, 4-70, 4-120 4-60, and 4-80.

This game enables players to play numerous hands simultaneously, which is very popular in casinos, apparently because it gives players the illusion that they have a better chance of winning. Also, the player can play a large number of hands simultaneously with relatively few cards on the screen.

In this game, after the cards are dealt, each hand could be immediately compared to a paytable to determine winnings. Alternatively, the player could select hold cards and have the non-held cards replaced. In another alternative, the hands could be compared to a dealt hand rather than a paytable.

Also, bonus or progressive jackpot payments could be given. For example, if a joker deck is used and if a joker is in one of the outer most corners (i.e. cards, 4-10, 4-30, 4-110 and 4-130), or if four aces are dealt in those four corners a bonus or progressive jackpot could be awarded. Similarly, bonus payments could be made if a joker is dealt in the center (i.e. card 4-70).

1. A poker game with five or seven cards dealt per side, each hand forms the side of a closed figure and the corner cards are common to the adjacent hands.

2. The game of claim 1 where cards are dealt in a four-sided pattern.

3. The game of claim 1 where the cards are dealt in a diamond pattern and cards are also dealt in the interior of the diamond forming a cross shape, so that the horizontal and vertical cards that form the cross could be separate hands.

4. The game of claim 1 where the cards are dealt in a diamond pattern and cards are also dealt in the interior of the diamond forming a cross shape, so that the horizontal and vertical cards that form the cross could be separate hands, and the center card would be a bonus card.

5. The game of claim 1 where a bonus is awarded depending on the value of the card or cards in the corners.

6. The game of claim 1 where one or more diamond figures are interlinked.

7. An electronic device that has one or more screens which display five or seven cards on each side of a closed figure.

8. The electronic device of claim 7 where cards are displayed in a diamond pattern.

9. The electronic device of claim 7 where the cards are displayed in a diamond pattern and cards are also displayed in the interior of the diamond forming a cross shape, so that the horizontal and vertical cards that form the cross could be separate hands.

10. The electronic device of claim 7 where the cards are displayed in a diamond pattern and cards are also dealt in the interior of the diamond forming a cross shape, so that the horizontal and vertical cards that form the cross could be separate hands, and the center card would be a bonus card.

11. The electronic device of claim 7 where a bonus is awarded depending on the value of the card or cards in the corners.

12. A method of playing cards in which the cards are displayed in a diamond pattern with five or seven cards displayed on each side.

13. A five-card poker game where the five cards are displayed in a diamond shape such that one card is in each corner and the fifth card is in the center of diamond.

14. The game of claim 13 where multiple diamond-shaped hands are dealt so that the corner cards are common to the adjacent hand or hands.

15. The game of claim 13 where the player is permitted to pay for the number of hands the player wants to play.

16. A computer running all or part of a program such that the screen displays cards in a diamond pattern so that one card is in each corner and a fifth card is in the center of the diamond.

17. The computer of claim 16 where there are multiple diamond-shaped hands such that the corner cards are common to the adjacent hand or hands.

18. The computer of claim 16 where the player is permitted to pay for the number of hands the player wants to play.

19. The game of claim of claim 13 where the cards are arranged in a square pattern rather than a diamond pattern.

20. The game of claim 13 where multiple hands are dealt in square patterns so that the corner cards are common to the adjacent hand or hands.

21. The game of claim 13 where the player is permitted to pay for the number of hands the player wants to play.
